(19) United States
(12) Patent Application Publication
(10) Pub. No.: US 2004/0225524 A1
(43) Pub. Date: Nov. 11, 2004

(54) Systems and methods for monitoring the presence of assets within a system and enforcing policies governing assets

(75) Inventors: Anand Narasimhan, Berkeley, CA (US); Doron Myersdorf, Foster City, CA (US)

Correspondence Address: Anand Narasimhan, InnerPresence Networks, Inc., Suite 214, 1670 South Amphlett Blvd, San Mateo, CA, 94402, US

(73) Assignee: InnerPresence Networks, Inc.

(21) Appl. No.: 10/830,370

(22) Filed: Apr. 22, 2004

Related U.S. Application Data
(63) Continuation of application No. 10/339,925, filed on Jan. 9, 2003, now abandoned.
(60) Provisional application No. 60/347,124, filed on Jan. 9, 2002.
(60) Provisional application No. 60/347,125, filed on Jan. 9, 2002.
(60) Provisional application No. 60/387,737, filed on Jun. 11, 2002.

(51) Int. Cl. G06F 17/60

(52) U.S. Cl. 705/1

(57) ABSTRACT

A system can be used to enforce policy driven interactions among any set of objects. The availability of objects within a system is monitored and policies applicable to the objects are enforced. Objects within the system such as users, devices, processes and information assets are assigned unique identifiers and their presence is periodically reported to a server by client agents running in the devices. The availability of an object for a specific interaction may be determined through analysis of the presence of the object in the system and the presence and attributes of objects required to facilitate the interaction. Policies are associated with each of the objects. When an attempted interaction of objects is detected by a client agent, a license governing the attempted interaction is dynamically generated in accordance with policies associated with each of the objects participating in the interaction. The interaction is thereafter regulated by the client agent in accordance with the dynamically generated license.

### RELATED APPLICATIONS

This application claims priority under 35 USC § 119(e) from U.S. provisional application 60/347,124 filed 9 Jan. 2002, U.S. provisional application 60/347,125 filed 9 Jan. 2002, and U.S. provisional application 60/387,737 filed 11 Jun. 2002, the entirety of each of which is incorporated herein by reference.

### BACKGROUND OF THE INVENTION

1. Field of the Invention

Embodiments of the invention relate to electronic systems such as communication systems and computer systems, and more particularly to determination of the availability of system assets such as users, devices, processes, and information assets, and the enforcement of policies regarding system assets.

2. Related Technology

Computer and communication system are often relied upon to store and convey valuable information. It is therefore desirable to be able to monitor system users, system devices and processes, and information contained within the system, to track the availability of assets within the system, and to develop and enforce policies governing the use of the system.

Availability tracking in conventional systems typically indicates only the simple presence or absence of an element of the system. For example, in conventional instant messaging systems, a user is provided with a list of people who are available for instant messaging by virtue of being present at devices that enable instant messaging. However this availability is not context-specific. For example, an individual who is shown to be available for instant messaging is available for all instant messaging, though at times that person may wish to restrict his availability to messages exchanged with work colleagues.

A variety of policy enforcement schemes are known. One type of scheme is a user or device-oriented approach, whereby obstacles are created to prevent unauthorized users from using devices that provide access to the system. For example, user authentication systems such as computer network passwords and public key encryption may be employed to ensure that only certain individuals are able to use certain devices and obtain access to certain information. However, a user who has traversed such obstacles by providing an appropriate user id and password or an appropriate decryption key is thereafter free to access and distribute information or engage in other unauthorized uses of the system. Therefore this approach cannot prevent successful attacks by malicious users or negligent policy breaches by valid users.

A second approach is a document-based approach that involves monitoring access to information. For example, document management systems provide a central repository for storing information and users are required to check out the documents in order to have access to them, thus creating a history of document access. Again, however, once a document is checked out to a user that user is free to print, make copies of, alter or disseminate the document in an unregulated manner.

A further approach to information security is digital rights management. Digital rights management schemes typically encapsulate an information use policy with information data, such that use of the information is restricted to those uses permitted by the policy. For example, a policy attached to an audio file may limit the use of that file to a particular person and a particular device. However, digital rights management policies are user-centric and device-centric, in that the policies specify a specific set of limitations for a particular user or a particular device. The owner of the information must therefore independently generate specific policies for each person or device to which the information is distributed.

A further approach to information security is content filtering. For example, an email security system may filter the content of email messages sent into and out of the system by searching for fixed character strings within email messages. However, such filtering is done without regard to the identity of the sender or receiver, or to the devices to which and from which the messages are transmitted.

It is therefore seen that the aforementioned approaches to policy enforcement all suffer from various degrees of inflexibility in regard to their abilities to customize their actions based on the particular people, devices and information involved, while typical availability determination lacks the ability to determine the availability for particular contexts of interaction.

### SUMMARY OF THE INVENTION

Embodiments of the invention pertain generally to systems and methods for making context-specific determinations of the availability of system assets for interactions with other assets, and for enforcing policies governing the behavior of those assets based on the particular assets that are interacting in a given transaction.

In accordance with embodiments of the invention, a system is treated as including “assets,” which are objects within the system to which behavior-regulating policies are to be applied. In accordance with a preferred embodiment, system assets include users, devices, processes and information, however other types of assets may also be included. Each asset is assigned an identifier that uniquely identifies it within the system, and each asset has associated therewith a set of policies that govern its behavior. Asset identifiers and associated policies are stored in one or more proxy servers within the system.

Each device within the system includes or has associated therewith an agent for providing availability determination and policy enforcement services through interaction with the proxy server. The agent facilitates availability determination by periodically reporting the identifiers of each asset present at their corresponding devices. The availability of an asset in the context of interaction with a particular combinations of other assets may then be determined based on the presence information and policies associated with each participating asset.

Policy enforcement is provided by dynamically generating a license governing an interaction of assets at the time that the interaction is first attempted, and subsequent regulation of the interaction in accordance with the rights granted in the license by one or more agents at devices where the interaction occurs. The license is dynamically generated based on the policies or licenses associated with each of the assets participating in the interaction. In various configurations a license may be dynamically generated by an agent in a device or by the server.

### DESCRIPTION OF THE DRAWINGS

Preferred embodiments of the invention are described in conjunction with the following figures, in which:

FIG. 1 shows an exemplary system configuration in accordance with one preferred embodiment of the invention;

FIG. 2 shows elements in a device and a proxy server of the embodiment of FIG. 1;

FIG. 3 shows a detailed view of elements of a client agent in a device;

FIG. 4 shows a detailed view of elements of an agent in a proxy server;

FIG. 5 shows an example of interaction of a device agent and a proxy server agent;

FIG. 6 shows the components of a license governing an interaction among assets in accordance with a preferred embodiment;

FIG. 7 shows a further example of interaction of a device agent and a proxy server agent;

FIG. 8 shows an encapsulation process in accordance with a preferred embodiment;

FIG. 9 shows an exemplary system configuration in accordance with a further preferred embodiment;

FIG. 10 illustrates the relationship of a license for a particular interaction of assets to policies and licenses applicable to the assets participating in the interaction;

FIG. 11 shows an exemplary system configuration in accordance with a further preferred embodiment;

FIG. 12 shows a process for determining availability of an object encompassing the preferred embodiments and alternative embodiments; and

FIG. 13 shows a process for enforcing policies encompassing the preferred embodiment and alternative embodiments.

### DETAILED DESCRIPTION OF PREFERRED EMBODIMENTS

As used herein, the term “assets” describes classes of objects within a system to which behavior regulating policies are applied. In the preferred embodiment, the types of assets include users, devices, processes and information, and policies may be applied to any object in the system that is deemed to fall within one of these classes. In other embodiments, additional types of assets may be defined.

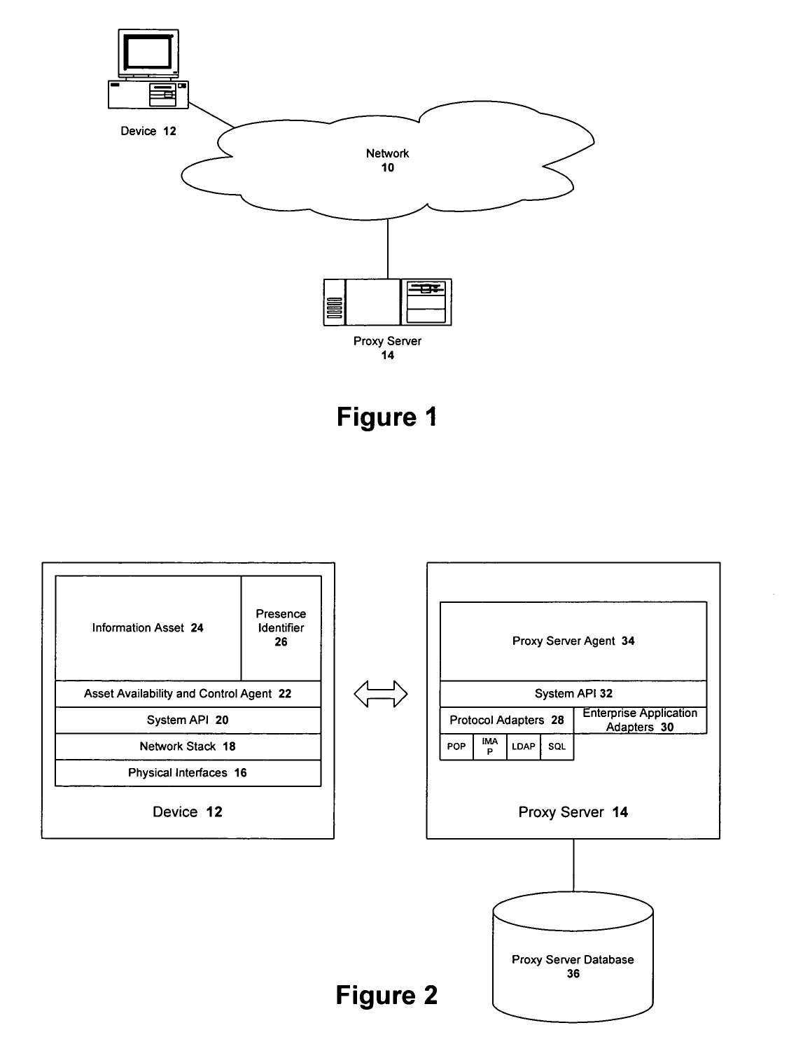

FIG. 1 shows an exemplary high level system architecture in accordance with one implementation of a preferred embodiment of the invention. In this embodiment, a device 12 is connected to a network 10, to which is also connected a proxy server 14. An agent in the device 12 interacts with an agent in the proxy server 14 to provide two features that are central to the preferred embodiment: determining the availability of assets within the system in the context of interactions with specific combinations of other assets, and managing the interaction of assets within the system in accordance with policies.

Availability determination is facilitated by assigning a unique identifier to each user, device, process and information asset within the system. A wide variety of identifiers may be used, and it is preferable to use identifiers that are already present in the system, such as UNC addresses, IP addresses, SIP addresses, email addresses, document names, physical object address, or pointers to devices that control access to an asset. An identifier is assigned to an asset at the time of its creation, such as the creation of a new user, the addition of a new device to the system, the creation of a new process, or the creation of a new information asset (e.g. creation of a new document or an instance of a preexisting document). Security policies associated with the new asset are also created at that time. For purposes of describing embodiments of the invention, the term policies is used to describe a definition of the rights of an asset outside of the context of a particular interaction with other assets, while the term license is used to describe a set of particular to the context of an interaction of specific assets. An agent in the device 12 periodically informs the proxy server 14 of each asset that is present at the device, thus allowing for monitoring of the location of assets within the system. The availability of an asset for a particular interaction may then be determined in accordance with the presence information and the policies applicable to each of the participating assets.

Application of policies to the behavior of system assets is accomplished by regulating interactions among assets in accordance with dynamically generated licenses that are generated based on respective policies associated with each of the assets involved in the interaction. Depending on various considerations, the license for a particular interaction of assets may be dynamically generated by the agent in a device, or may be dynamically generated at the proxy server and then provided to the agent in the device. Enforcement of the policies of the license is accomplished at the device 12 by the agent in the device based on decisions made by either the device agent or the proxy server 14.

While the embodiment of FIG. 1 shows a single device and a single proxy server, in alternative embodiments any number and type of devices may be included in the system, and proxy server functionalities may be distributed across multiple proxy servers.

FIG. 2 shows elements of the device 12 of the embodiment of FIG. 1. The device 12 includes conventional elements such as physical interfaces 16, a network stack 18 and a system application programming interface (API) 20. The device 12 further includes an asset availability and control agent 22, referred to hereinafter as a client agent. The client agent 22 interfaces with the system API 20 and provides the services that enable availability determination and policy enforcement at the device 12.

The device 12 of FIG. 2 is further shown as including an information asset 24, such as a document or a data file. Associated with the information asset 24 is an identifier 26 that uniquely identifies the information asset 26 within the system. Identifiers are further associated with all other information assets that are present at the device 12, including the device 12 itself, any users who are accessing the system through the device 12, process running on the device including the client agent, and other information assets that are stored in the device such as data and licenses.

FIG. 2 further shows elements of the proxy server 14 of the embodiment of FIG. 1. The proxy server 14 includes conventional elements such as protocol adapters 28 and enterprise application adapters 30 and a system API 32. The proxy server 14 further includes a proxy server agent 34, referred to hereinafter as a server agent. The server agent 34 interfaces with the system API 32 and provides services that enable availability determination and policy enforcement. The proxy server 14 also includes a proxy server database 36. The proxy server database 36 is a relational database that stores information including asset identifiers and attributes, locations of assets, policies and licenses associated with assets, authentication keys associated with assets, and audit information.

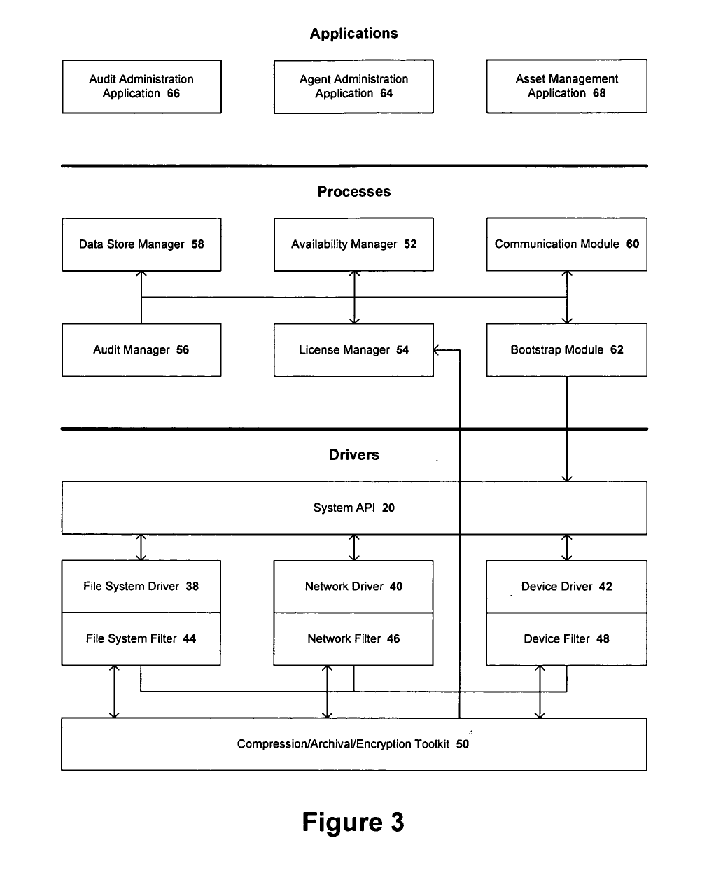

FIG. 3 shows elements of the client agent in the device of FIG. 2. At the driver level, the client agent includes filters associated with respective system drivers. A file system filter 44 is interfaced with the file system driver 38 for detecting attempted file system accesses, for example, by applications such as Windows Explorer. A network filter 46 is interfaced with the network driver 40 for detecting all attempted network activity on all ports of the device. A device filter 48 is interfaced with a device driver 42 for detecting all attempted uses of external devices such as printers and media devices. The function of the filters is to detect and report any attempted uses of the drivers so that those uses can be evaluated to determine whether they are permitted by licenses governing the behavior of the assets attempting those uses. The filters further serve as gateways that either permit or prevent such uses from taking place. The filters preferably provide complete information at the driver level to enable detection of all attempted interactions among system assets, and that the client agent therefore preferably includes filters corresponding to all drivers of the device on which it operates.

The client agent further includes a compression/archival/encryption toolkit 50. The toolkit provides various compression, archival and encryption services that may be required for purposes of data access in accordance with applicable licenses.

At the process level, the client agent includes an availability manager 52. The availability manager 52 monitors the presence of assets at the device and periodically reports the identifiers of assets present at the device to the proxy server. The availability manager 52 further interacts with the proxy server to determine the availability of system assets for interaction with other system assets.

A license manager 54 in the client agent provides creation, modification and enforcement of licenses by the client agent. The license manager 54 receives information regarding detected attempted actions from the filters 44, 46, 48, and determines whether the attempted actions are permitted in accordance with the licenses governing the assets involved in the attempted actions. The license manager 54 then instructs the filters to either permit or prevent attempted actions at the driver level based on its decisions regarding applicable licenses. The license manager 54 is also responsible for generating licenses for a new interaction of assets based on the licenses governing the participating assets.

An audit manager 56 of the client agent generates audit information representing all decisions made and actions taken by the license manager 54. A data store manager 58 stores the audit information generated by the audit manager 56. The audit information is periodically reported to a proxy server where it is archived for analysis.

The client agent further includes a communication module 60 that provides communication between the client agent and proxy servers and other client agents.

A bootstrap module 62 of the client agent provides installation of the client agent. The bootstrap agent preferably provides incremental installation of components of the client agent based on the need for those components at the client agent. Client agent components are typically obtained from a proxy server.

At the application level the client agent includes an agent administration application 64. The agent administration application 64 provides client installation and configuration services. The client agent further includes an audit administration application 66 that allows configuration of the format and other parameters of audit information generated by the audit manager 56. The client agent also includes an asset management application 68 that enables the user to view the assets under management within the system and to bring in new assets or remove existing assets from management.

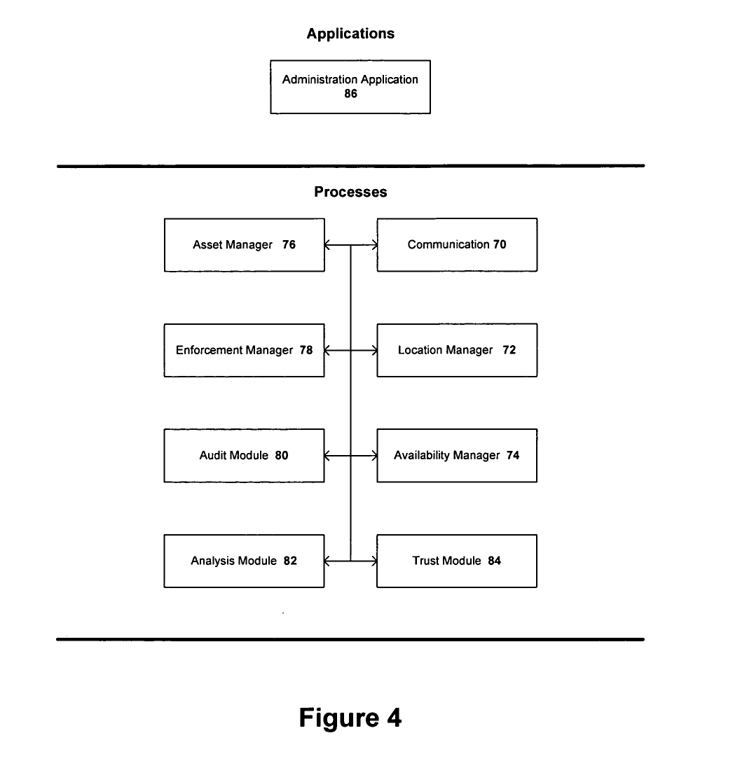

FIG. 4 shows elements of the server agent in the proxy server of FIG. 2. At the process level, the server agent includes a communication module 70 that provides communication between client agents of the system and processes within the proxy server. The communication module 70 is also responsible for establishing sessions among interacting assets by providing any authentication or signaling services needed to establish communication among assets.

A location manager 72 manages and provides information regarding the locations of assets in the system, for example, the address at which a computing device is located. The location manager 84 may use well-known methods including directory systems such as LDAP, active directory, or other systems such as registries, UDDI methods. An availability manager 74 manages information regarding the presence of all assets within the system, and provides context-specific information to other processes in the server and to client agents concerning the availability of assets for interaction with combinations of other assets.

An asset manager 76 is responsible for issuing identifiers for assets within the system. The asset manager 76 also manages all information concerning the properties and attributes of assets of the system, such as their capabilities, file types, of configurations, and provides information regarding properties of assets to other processes in the server and to client agents. Property and attribute information is typically provided to the proxy server by client agents in conjunction with reporting the presence of assets. An enforcement manager 78 manages licenses associated with system assets, generates licenses and communicates with the license managers in client agents regarding licenses.

An audit module 80 receives audit data from client agents, manages the storage of audit data in the proxy server database, and provides audit data to other processes. An analysis module 82 analyzes the audit data received by the proxy server to search for patterns of asset behavior and use that indicate system malfunctions, threats and security breaches. The analysis module 82 may perform further analysis to predict the likelihood of future interactions between assets using probability theories, deterministic rules, pattern matching or an expert system employing a priori knowledge of asset interactions and relationships.

A trust manager 84 serves as a third party trust authority that allows client agents to validate requests for interactions of assets. For example, the trust manager provides authentication of users through distribution of encryption and decryption keys to client agents.

At the application level, the server agent includes an administration application 86 that enables a user to configure and administer the proxy server agent.

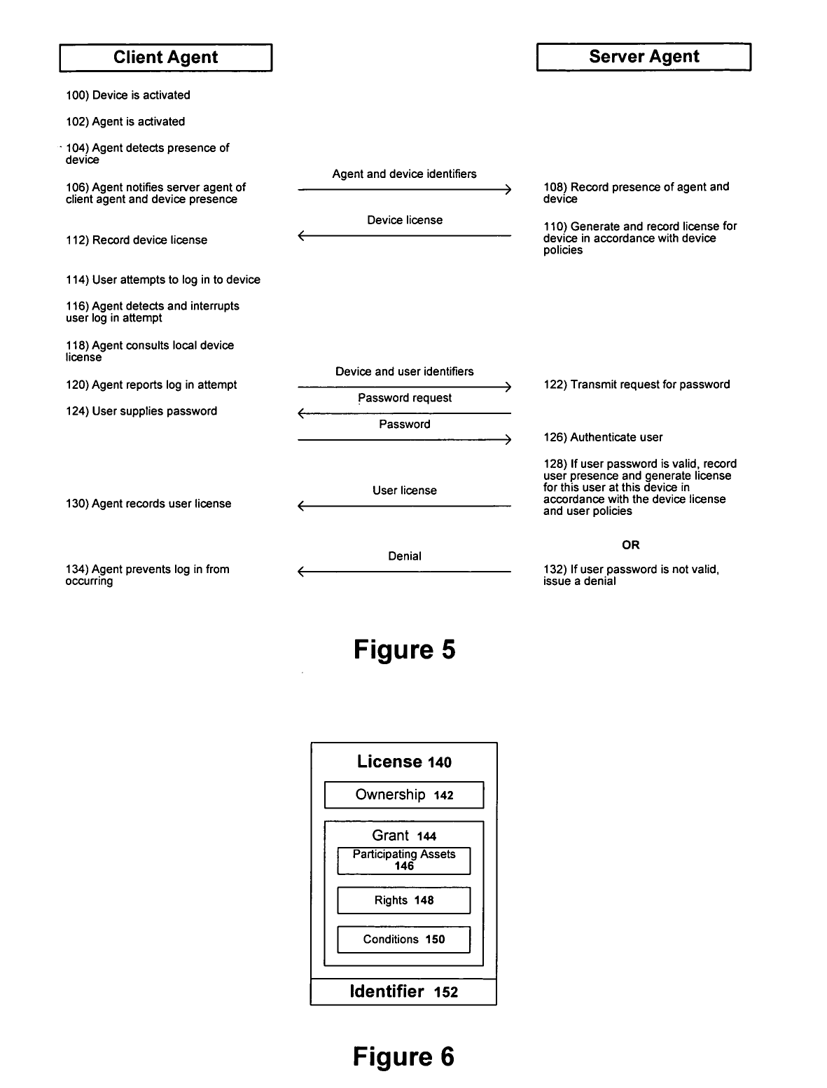

Basic interactions of the device 12 and proxy server 14 of FIGS. 1-4 are now described with reference to FIGS. 5-8. FIG. 5 shows basic interactions that typically occur upon the activation of the device 12. Referring to FIG. 4, when the device is activated (100), the client agent within the device becomes activated (102), and the client agent detects the presence of the device (104) by searching for asset licenses presently stored in the device. The availability manager of the client agent then notifies the server agent of the presence of the agent and the device (106) by transmitting to the server agent the identifiers of the client agent and the device that are stored in the respective licenses of the device and the agent. In the server agent the availability manager records the presence of the client agent and the device (108), thus making knowledge of the availability of the client agent and the device potentially available to other assets in the system. The enforcement manager in the server agent generates and records an updated license for the device based on current policies for the device stored in the proxy server database (110), and if a valid license can be generated for the device the license is transmitted to the client agent. The updated device license is received at the client agent through the communication module and is provided to the license manager where it is recorded (112).

Subsequently, a user attempts to log in to the system through the device (114). The log in attempt is detected and interrupted by the network filter of the client agent and is reported to the license manager of the client agent (116), which consults the local copy of the device license to determine whether the log in attempt can be permitted or denied based on the local device license (118). For purposes of this example it is assumed that the local device license specifies that all log in attempts at this device must be validated through the proxy server. Accordingly, the license manager reports the log in attempt to the server agent (120) by providing the user identifier supplied by the user during the log in attempt. It is assumed for purposes of this example that the supplied user identifier serves as an identifier of the user within the system. At the server agent, the asset manager in conjunction with the trust module initiates a validation process by sending a request for a password to the client agent (122). The client agent prompts the user for and receives a password (124) which is sent to the server agent. At the server agent, the user is validated by the asset manager in conjunction with the trust module (126). If the password supplied by the user is valid, the server agent availability manager records the user presence at the device, and the enforcement manager generates a license for the user based on the restrictions present in the device license and the policies associated with the user in the proxy server database (128). The user license is transmitted to the client agent where it is recorded by the license manager (130) and the log in procedure is completed through appropriate instructions from the license manager to the network filter. The user is thereafter permitted limited access to the system in accordance with the user license. Alternatively, in the event that the user's password is not validated, the server agent issues a denial (132) which is transmitted to the client agent. At the client agent the denial is provided to the license manager, which prevents the completion of the log in attempt through appropriate instructions issued to the network filter (134).

For purposes of better understanding of the preceding example and further examples provided below, the components and generation of a license are discussed with respect to FIG. 6. A license 140 is comprised of two major components: an indication of ownership 142, and a grant 144. The grant 144 defines the behavior that is permitted in accordance with the license, while the ownership 142 indicates the asset to which the grant applies. Ownership 142 of a license is typically indicated by an asset identifier. The license grant 144 is comprised of three components: an indication of participating assets 146, a definition of the rights 148 of the license owner as determined in accordance with the licenses or policies applicable to the participating assets, and a definition of additional conditions 150 of the license that are not specifically derived from other participating assets. For example, the user's access through the device may be limited to certain times of day and certain days of the week.

To illustrate the license grant in more detail, in the case of the user log in described above, the user seeks permission to interact with the device at which the log in is attempted, and the user is granted a license that regulates the user's behavior while logged in at that particular device. The user is therefore the owner of the license, and the license reflects this by utilizing the user's identifier to indicate ownership. The grant is specific to the assets involved in this interaction, namely the user and the device. Accordingly, the participating assets are the user, which has policies associated therewith in the proxy sever, and the device, for which a license was previously granted. The rights defined in the license are determined based on the policies applicable to the user, and the rights of the device previously defined in the device license. For example, the device license may indicate that the device may only be used by users having given security levels, with each security level entitling the user to various sets of functionalities (e.g. a high level users may send email, access files and browse the internet, while a low level user may only read email), and may further indicate that the device can only be used to access documents having no security restrictions. Further, the policies associated with the user may specify a security level for the user, and may also globally restrict the device functionalities that the user is entitled to use. As a result, the license generated for this user's interaction with this device will be limited based on the particular user's security level and global restrictions, as well as the particular restrictions already imposed by the device license. Thus it is seen that the terms of the license will depend on the particular rights defined in the device license grant and the particular policies applicable to the user. In other words, the license grant is generated dynamically for this interaction based on the licenses and policies applicable to each of the assets involved in the interaction.

It is further noted that, like other information assets within the system, the license is assigned an identifier 152 that uniquely identifies it within the system.

In accordance with the preferred embodiment, the license is expressed using a digital rights management license language such as XrML or ODRL. XrML is an adaptation of the XML language that provides data tags for expressing restrictions in digital rights management licenses. In accordance with the preferred embodiment of the invention, the capabilities of XrML and ODRL are enhanced by providing processes in the server agent and in the client agent that generate interaction-specific license grants based on the grants defined in licenses owned by the assets participating in the interaction for which the license is being generated.

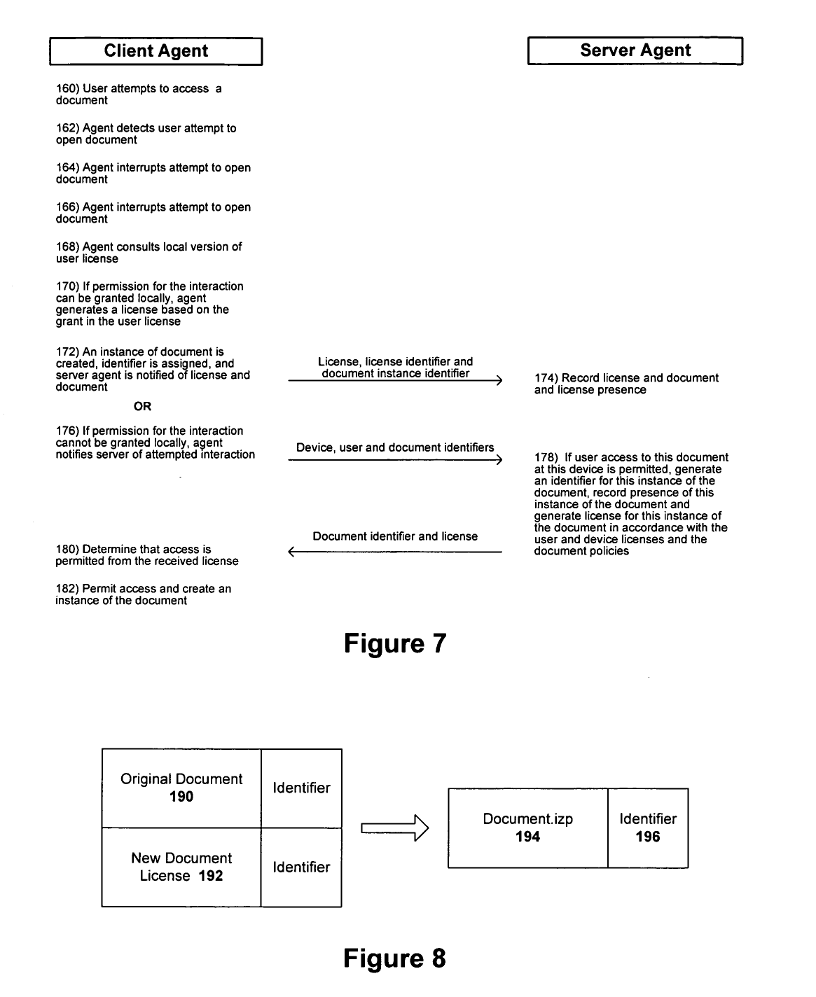

FIG. 7 shows a further example of interaction between the client agent and server agent of FIGS. 1-4 in a case where a user attempts to access an information asset such as an electronic document by means of the device. Referring to FIG. 7, when a user attempts to access a document (160), the attempted access is detected by the file system filter of the client agent (162), which notifies the license manager. The client agent interrupts the attempted access (164) by means of appropriate instructions from the license manager to the file system filter, and obtains a copy of the document for purposes of assessing the access request in accordance with the document license (166). It is noted that this is a version of the original document that is obtained for purposes of license application and it is not made available to the user at this time. The license manager of the client agent then consults the local version of the user's license and the document license to determine whether this attempted interaction of assets, i.e., access to the specified document by this user at this device, is permitted under the user's license (168). If a local determination that the interaction is permitted can be made through reference to the local licenses, a license specific to the document and owned by the user will be generated by the license manager of the client agent in accordance with the user's license and the original document license to govern the use of the document by the user (170). In the event that a license is generated, an instance of the document for use by the user is created at the device and is assigned an identifier, and the server agent is notified of the presence of this instance of the document and the license, and is provided with a copy of the license (172). The asset manager of the server then records the license and the availability manager of the server records the presence of the license and the instance of the document at the device (174).

In many instances it is not possible for the client agent to grant access locally. For example, the document license may require that the a user must be validated through the server agent before being permitting access to this document. As another example, the user's license may require that all documents accessed on this device be encrypted using a key supplied by the trust module of the server agent, which requirement may be derived from requirements of the license for the device on which the document is being accessed. In such instances where access cannot be granted locally, the license manager of the client notifies the server agent of the attempted access (176) by sending the identifiers of the device, the user and the document. At the server, the enforcement manager receives the identifiers, and determines whether the access is permitted based on the device, user and document licenses. If access is permitted, an identifier for an instance of the document is generated by the asset manager, the presence of the document is recorded by the availability manager, and the document license and document identifier are transmitted to the client agent (178).

Upon receipt of the license, the license manager of the client agent determines from the license that the access is permitted (178), and permits creation of an instance of the document through appropriate commands to the file system filter (180).

In accordance with this preferred embodiment of the invention, documents and other information assets are encapsulated before being made available locally to users of devices. The encapsulation process is illustrated in FIG. 7. Encapsulation combines a copy of the original document 190 with the license 192 that has been generated for the new instance of the document to which the user is granted access. The combined document 190 and license 192 are then encrypted or otherwise converted in some fashion to yield a single encapsulated document 194 having a file name extension indicating that it is an encapsulated document. The identifier 196 generated for this instance of the document is associated with the encapsulated document. The encapsulated document is the locally stored version that the user is permitted to access, and the encryption and decryption that is required to facilitate that access is provided by the toolkit of the client agent. By encapsulating in a single encrypted file the original document and the license that is specific to a particular user and device, the document is made useable only by devices that include a client agent capable of decrypting the file, and when used on a device having such a client agent, the uses of the document will be limited to those uses defined in the license.

As noted in the above example, the license manager of the client agent is capable of applying and generating licenses locally under some circumstances, which may eliminate the need to involve the proxy server in the decision regarding the ability of a given set of assets to interact in a given manner. In other instances the client agent may provide these services when a connection to a proxy server is not available. For example, in the case of assets and interactions for which licenses have been previously stored on a device, the local client agent may use the most recent local version of a license to determine whether an interaction is permitted. Preferably license grants include information indicating whether such a local determination may be made in the event of no connection to a proxy server. Where such action is permitted, the client agent preferably modifies the license to require an update of the license from the proxy server upon the next access to the document.

The foregoing examples illustrate interactions among client agents and server agents and their component processes that facilitate basic features of the preferred embodiment including detection of asset presence, determination of asset availability for particular interactions, and generation of licenses for specific interactions of assets based on the license grants or policies applicable to each of those assets. The following examples describe more complex interactions of multiple devices involving the use of availability determination and license generation.

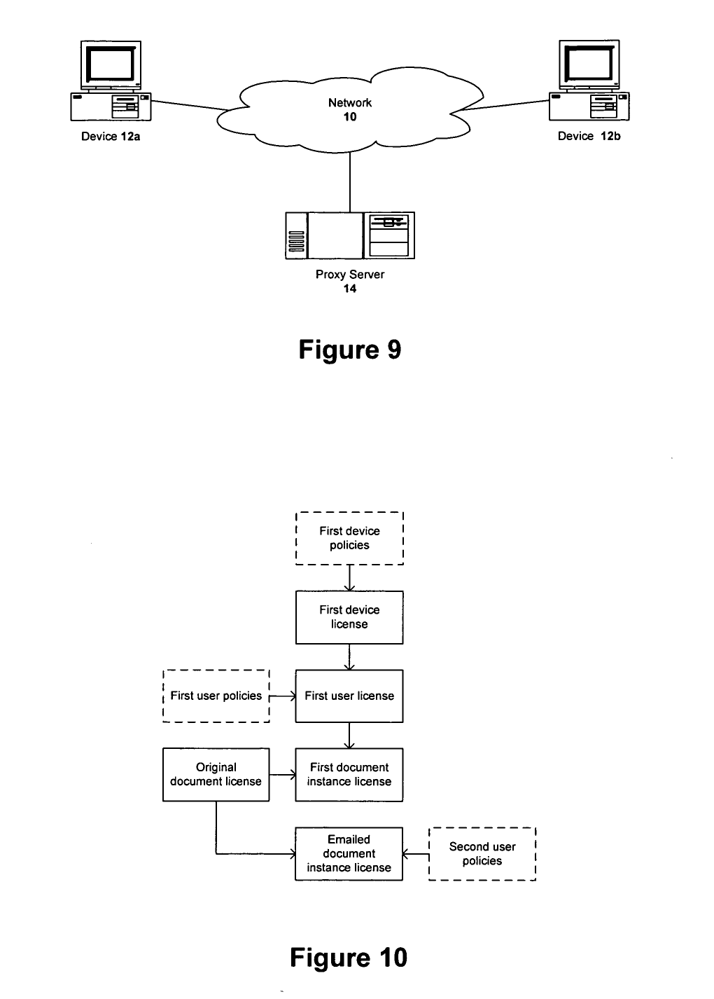

FIG. 9 shows a system comprising first and second devices 12a, 12b and a proxy server 14. It is assumed in this example that the devices and proxy server are essentially the same as those shown in FIGS. 2-4. It is further assumed in this example that the user in the example of FIG. 7 is now attempting to email the document accessed in FIG. 7 to a second user located at the second device 12b.

Upon attempting to email the document, the attempted interaction of the first user, the first device and the document with an email process and the second user is detected by a filter in the client agent. The attempted emailing is interrupted by the client agent and the original document license is inspected to determine whether emailing of the document to the second user is permitted. It is assumed for purposes of this example that the original document license requires the client agent to consult the proxy server in the event of an attempt to email the document. Accordingly, the client agent informs the proxy server of the identifiers of the document and the email recipient. Assuming that the second user is a recognized user who can be identified by the proxy server based on the second user's email address, the proxy server analyzes the document license and the policies associated with the second user to determine whether the document may be emailed to the second user.

If emailing is permitted, a grant for a license for an instance of the document to be received by the second user is generated based on the restrictions contained in the license for the instance of the document possessed by the first user, and the policies associated with the second user. The license is provided to the first device, where it is encapsulated with an instance of the document, and the encapsulated file is then emailed to the second user.

It is seen from this example that the license generated for a particular interaction of assets will include a grant that is derived from the licenses or policies associated with each of the participating assets. FIG. 10 shows the manner in which the policies and licenses associated with various participating assets contribute to the license issued for the instance of the document emailed to the second user. While this contribution appears to be hierarchical in nature in FIG. 10, it is noted that the series of license grants need not become more restrictive as each additional participating asset contributes. For example, restrictions in the license of the original document may prevent the first user from printing the document because of that user's security level. However, a license grant for an instance of the document to be emailed to the second user may permit emailing by the second user where the second user has the requisite clearance level.

The example of FIG. 9 may further be used to illustrate the determination of context-specific availability in the system. Assume now that the second user is logged into the second device, but that the license of the emailed document does not permit the document to be accessed at location of the second device for reasons of security. Under these circumstances, the document will have been successfully emailed to the second user, but it not available to the second user in the context of the particular interaction of that document with the second user and the second device. This determination of availability may be made by the client agent in second device upon an attempt to access email by the second user at the second device. Thus, for example, the second user may be permitted to access the email message and be informed of the attached document, but not open the attached document. This may be indicated, for example, though the display of an appropriate icon in the second user's email client. It is seen from this example that the availability of the document is specific to the context of the particular interaction of assets that is involved.

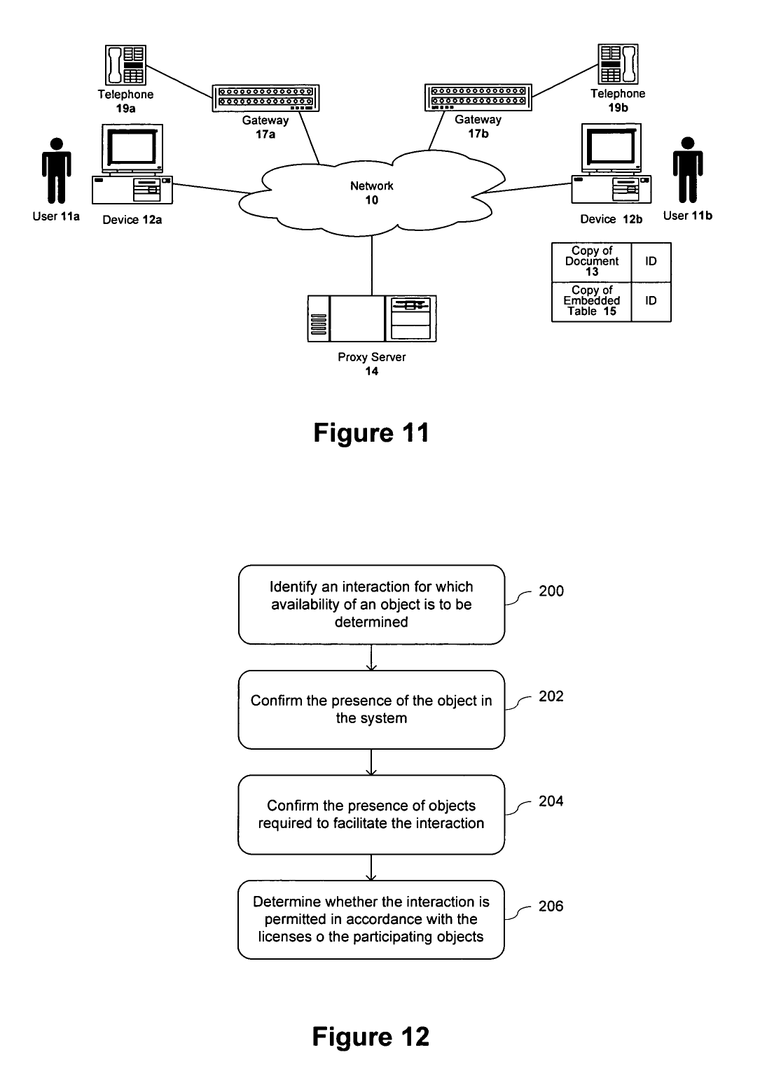

FIG. 11 shows a further example involving multiple devices and multiple types of devices. In the configuration of FIG. 11, two computing devices 12a and 12b are connected to a network 10. A user 11 is present at the first device 12a by virtue of being logged in to the system through the first device 12a. Present at the second device 12b is a copy of a document 13 including a copy of an embedded table 15. For purposes of this example, it is assumed that the user present at the first device 12a is the author of the original version of the document and table, and that licenses associated with the copies 13 and 15 indicate that they are copies of the original document and that any changes to the document 13 or table 15 must be approved by the author 11 of the original through a voice call to the author.

Also within the system at the locations of the respective devices 12a, 12b are telephones 17a, 17b that are connected to the network 10 through respective gateways 19a, 19b, thus enabling connections between the telephones to be made through the network using a voice over IP connection. For purposes of this example, it is assumed that the telephones are treated as assets of the system having identifiers associated therewith that enable the presence of the telephones 19a, 19b to be monitored by the proxy server 14. Since the telephones are “dumb” devices that do not have independent processing capabilities, client agents for the telephones are located in the gateways to which they are connected.

It is assumed now that the user 11b is attempting to change the table 15 at the second device 12b. The attempt to change the table 15 is an event that is detected by a client agent in the second device 12b. The event is reported to the proxy server 14, where it is determined that the license associated with the table requires any changes by this user 11b to be approved by the author 11a of the original. Thus the change requires an interaction of assets that includes a voice communication with the first user. Since the presences of the first user and the first telephone have previously been registered in the proxy server database through the interactions of the client agent presence managers and the server agent presence manager, the availability manager is able to determine from the proxy server database that the author 11a is present at the location of the first device 12a, and further determine that a telephone 19a is present at the same location. The location manager also determines that a telephone 19b is present at the location of the second device 12b where the second user is attempting to make changes to the table. The availability manager therefore determines that the author is available for the required voice communication.

The proxy server accordingly establishes a session involving the two telephones 19a, 19b (through their respective gateways 17a, 17b), the two devices 12a, 12b, the two users 11a, 11b, the document 13 and the table 15. A license and identifier are generated for the telephone call based on all of the contributing policies and licenses of the assets involved in the session, and a voice over IP telephone connection between the users 11a, 11b is then established through the network by the proxy server 14.

It is seen from the example of FIG. 11 that a proxy server implemented in accordance with the invention may be used advantageously in conjunction with signaling side devices in a communication network, thereby combining policy enforcement and availability determination with standard signaling side functions such as exchange of messages between devices. For example, in accordance with one preferred embodiment of the invention, availability determination and policy enforcement functions are combined with the signaling side functionality provided by the Session Initiation Protocol (SIP protocol) used for passing messages between next generation communication devices and for providing voice over IP functionalities. Thus, for example, communications using the SIP protocol may be regulated in accordance with security policies governing the devices used for communication, the users of those devices, and any information assets conveyed between the devices.

The example of FIG. 11 provides a further demonstration of the use of context-specific object availability in the system. Upon determining from the license associated with the document that the author's voice approval of changes is required, it becomes necessary to determine whether the author is available to provide voice authorization of those changes. Availability therefore depends first on the presence of the author in the system, i.e., whether the author is logged into a system device. This information is reflected in the proxy server database. Availability next depends on whether appropriate devices and connections are present to enable voice communication with the author, as well as document access for viewing the changes. The author's location is reflected in the proxy server database and may be obtained by the location manager of the server agent. The presence of various devices at the author's location as well as their attributes and connections are also reflected in the proxy server database and may be analyzed by the availability manager of the server agent. Finally, availability depends on whether the required interaction of assets necessary to establish the voice connection and document access is permitted in accordance with the licenses associated with all of the various participating assets. This may be determined by a license manager in the proxy server or in one of the participating devices. If the interaction is determined to be permitted, the author is determined to be available for the purpose of voice communication to approve changes to the document. This availability is preferably indicated to the user attempting the changes, for example by display of an icon such as in conjunction with a document list in a file system interface of the application being used to make the changes. In the event that the interaction is initiated, a license for the interaction is generated in the manner discussed above.

A process of determining availability in accordance with embodiments of the invention may therefore be performed as illustrated in FIG. 12. Initially an interaction for which an object's availability is to be determined is identified (200). The presence of the object within the system is then confirmed (202). The presence of additional objects within the system that are required to facilitate the interaction is then confirmed (204), and finally the respective licenses associated with the object and the additional objects required to facilitate the interaction are analyzed to determine whether the interaction is permitted (206). These tasks may be performed in the availability manager of a server agent or through interaction of the availability managers of a client agent and a server agent.

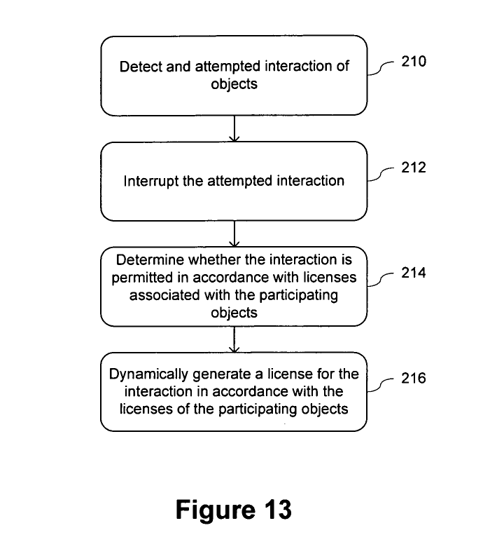

A process of enforcing policies in accordance with embodiments of the invention may therefore be performed as illustrated in FIG. 13. Initially and attempted interaction of objects is detected (210). The attempted interaction is interrupted (212), and it is determined whether the interaction is permitted in accordance with respective licenses associated with the objects involved in the interaction (214). If the interaction is permitted, a license governing the interaction is dynamically generated in accordance with the respective licenses associated with the objects participating in the interaction (216). These tasks may be performed in a server agent, in a client agent, or through interaction of a client agent and a server agent.

The aforementioned examples are intended to be illustrative for purposes of explaining the availability determination and policy enforcement features that may be implemented in accordance with various embodiments of the invention. It will be appreciated from these examples that wide range of alternative embodiments may be implemented. For example, while the examples are shown in the context of computer networks, embodiments of the invention may be implemented in a wide variety of other types of systems such as workflow systems, industrial networks, wireless network, telephone network, home networks and enterprise networks. Further, a wide range of devices may be treated as assets within the system, including PDAs, facsimile machines, audio and video systems and components, security devices, utility devices such as electrical, gas and water distribution devices, home and industrial appliances, and biometric signal acquisition devices. Additional types of information assets may include streaming media, voice and data instant messages, audio and video and image data files, facsimile data, email messages, text, audio and video instant messages, calendar data, schedule data, medical records, transaction records, online bids and bidding information, and buyer and seller information. Such information assets may be encapsulated through combination with a license and optionally through application of encryption or other data modification, in a manner that is suitable to the particular information asset. A wide variety of other objects may also be treated as system assets, including smart cards, storage media, biological objects such as samples and specimens, DNA sequences, financial instruments, chemical and pharmaceutical materials, and other physical and representative objects.

In accordance with further preferred embodiments, availability determination and policy enforcement features may be integrated with various well-known software clients such as file management programs, email programs, and word processing, document management and other well known office applications.

The specific embodiments set forth herein are intended to provide a thorough understanding of the present invention by way of specific examples. However, these embodiments merely particular embodiments, and those skilled in the art will be able to devise further embodiments which, although not explicitly described or shown herein, embody the principles of the invention, and are included within its spirit and scope. Furthermore, all examples and conditional language that have been recited herein are principally intended to aid the reader in understanding features of certain implementations of the invention and are not to be construed as limiting the scope of the invention to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that the block diagrams herein represent conceptual views of illustrative hardware and software embodying the principles of the invention. Similarly, it will be appreciated that flow charts, flow diagrams, pseudocode and the like represent various processes which may be substantially represented in computer readable media and so executed by a computer or processor. The functions described and illustrated herein may be provided through the use of programmable hardware employing a single dedicated processor, a single shared processor, or a plurality of individual processors, some of which may be shared. Moreover, explicit use of the terms “device”, “server”, or “computer” should not be construed to refer exclusively to hardware capable of executing software, and may implicitly include, without limitation, digital signal processor (DSP) hardware, read-only memory (ROM) for storing software, random access memory (RAM), and non-volatile storage. Thus, while the embodiments illustrated in the figures and described above are presently preferred, it should be understood that these embodiments are offered by way of example only. The invention is not limited to a particular embodiment, but extends to various modifications, combinations, and permutations that fall within the scope of the claimed inventions and their equivalents.

What is claimed is:

1. A method for enforcing policies that govern the behavior of assets within a system, comprising:
detecting an attempted interaction involving multiple assets;
interrupting the attempted interaction;
determining whether the interaction is permitted in accordance with policies associated with the respective assets involved in the interaction; and
if the interaction is permitted, dynamically generating a license governing the interaction of the assets in accordance with the policies associated with the respective assets participating in the interaction.

2. The method claimed in claim 1, wherein said policies associated with the assets involved in the interaction represent security policies applicable to the respective assets.

3. The method claimed in claim 1, wherein the license dynamically generated for governing the interaction of the assets is expressed using one of XrML and ODRL.

4. The method claimed in claim 1, wherein the attempted interaction is accessing of a document at a device by a user,
wherein the document, the device and the user are assets participating in the attempted interaction, and
wherein a license governing the accessing of the document is dynamically generated in accordance with policies associated with the document, policies associated with the user, and policies associated with the device.

5. The method claimed in claim 1, wherein the attempted interaction is an exchange of an information asset between users at respective devices,
wherein the users, the respective devices and the information asset are assets participating in the attempted interaction, and
wherein the license governing the exchange of the information asset is dynamically generated in accordance with policies associated with the users, policies associated with the devices, and policies associated with the information asset.

6. The method claimed in claim 5, further comprising:
encapsulating the license governing the exchange of the information asset with an instance of the information asset to form an encapsulated information asset; and
exchanging the encapsulated information asset between the users.

7. The method claimed in claim 6, wherein the information asset comprises an electronic document.

8. The method claimed in claim 6, wherein the information asset comprises an email message.

9. The method claimed in claim 6, wherein the information asset comprises at least one of video data and audio data.

10. The method claimed in claim 6, wherein the information asset is real time data.

11. The method claimed in claim 10, wherein the real time data is one of a data stream and buffered data.

12. The method claimed in claim 6, wherein the information asset is exchanged in accordance with the session initiation protocol (SIP protocol), thereby incorporating enforcement of policies with SIP message exchange.

13. The method claimed in claim 1, wherein each of the assets is one of a user, a device, a process and an information asset.

14. A device for providing user access to information assets, the device comprising an agent for enforcing policies that govern the behavior of system assets including the user, the device and information assets accessed by the device, the agent performing processing comprising:
detecting an attempt by the user to interact with an information asset using the device;
interrupting the attempted interaction;
obtaining a dynamically generated a license governing the attempted interaction in accordance with policies associated with the device, policies associated with the user and policies associated with the information asset; and
regulating the interaction in accordance with the dynamically generated license.

15. The device claimed in claim 14, wherein the dynamically generated license is obtained by dynamically generating the license locally at the programmable device.

16. The device claimed in claim 14, wherein the dynamically generated license is obtained by:
informing a server of identities of the user, the device and the information asset; and
receiving the dynamically generated license from the server.

17. The device claimed in claim 14, wherein the device is a computing device.

18. The device claimed in claim 17, wherein the information asset comprises an electronic document.

19. The device claimed in claim 17, wherein the information asset is real time data.

20. The device claimed in claim 19, wherein the real time data is one of a data stream and buffered data.

21. The device claimed in claim 17, wherein the information asset comprises a data file.

22. The device claimed in claim 17, wherein the information asset comprises at least one of an audio data stream and a video data stream.

23. The device claimed in claim 17, wherein the information asset comprises an email message.

24. The device claimed in claim 14, wherein the device is a mobile communication device.

25. A device for enforcing policies that govern the behavior of assets within a system, the device comprising an agent performing processing comprising dynamically generating a license governing an attempted interaction of assets of the system in accordance with policies associated with the respective assets participating in the attempted interaction.

26. A programmable device comprising an agent for providing a context-specific determination of the availability of an asset within a system for an interaction with other assets of the system, the agent performing processing comprising:
identifying an interaction for which an asset's availability is to be determined;
confirming the presence of the asset within the system;
confirming the presence of additional assets within the system that are required to facilitate the interaction; and
analyzing respective policies associated with each of the asset and the respective additional assets to determine whether the policies allow the asset to be available for interaction with the additional assets.

27. The device claimed in claim 26, wherein, if the asset is available, the asset is indicated to a user as being available for said interaction.

28. The device claimed in claim 27, wherein the asset is indicated as being available by display of an icon to a user.

29. The device claimed in claim 26, wherein the interaction for which the asset's availability is to be determined is identified in accordance with a policy associated with an asset requiring the interaction.

30. The device claimed in claim 26, wherein the presence of the asset within the system is confirmed from presence information stored in a proxy server database.

31. The device claimed in claim 26, wherein the presence of additional assets within the system that are required to facilitate the interaction is confirmed from presence information for said assets stored in a proxy server database.

32. The device claimed in claim 31, wherein the presence of additional assets within the system that are required to facilitate the interaction is further confirmed from attribute information for said assets stored in a proxy server database.

33. The device claimed in claim 26, wherein the interaction for which an asset's availability is to be determined is a voice communication to a user,
wherein confirming the presence of the asset within the system comprises determining that the user is present in the system, and
wherein confirming the presence of additional assets within the system comprises determining that devices and connections required to establish a voice communication with the user are present in the system.

34. The device claimed in claim 26, wherein the interaction for which an asset's availability is to be determined is access to a data file,
wherein confirming the presence of the asset within the system comprises determining that the data file is present in the system, and
wherein confirming the presence of additional assets within the system comprises determining that devices and connections required to access the data file are present in the system.

35. The device claimed in claim 26, wherein the interaction for which an asset's availability is to be determined is a voice communication with a user to approve changes made to a data file,
wherein confirming the presence of the asset within the system comprises determining that the user is present in the system, and
wherein confirming the presence of additional assets within the system comprises determining that devices and connections required to establish a voice communication with the user are present in the system and that devices and connections required to enable the user to view the data file are present in the system.

36. The device claimed in claim 26, wherein said processing further comprises dynamically generating a license governing the interaction in accordance with policies associated with assets participating in the interaction.

37. A method for providing a context-specific determination of the availability of an asset within a system for an interaction with other system assets, comprising:
identifying an interaction for which an asset's availability is to be determined;
confirming the presence of the asset within the system;
confirming the presence of additional assets within the system that are required to facilitate the interaction; and
analyzing policies associated with each of the asset and the respective additional assets to determine whether the policies allow the asset to be available for interaction with the additional assets.

38. The method claimed in claim 37, wherein said processing further comprises dynamically generating a license governing the interaction in accordance with policies associated with assets participating in the interaction.
